(19) United States
(12) Patent Application Publication
(10) Pub. No.: US 2007/0271963 A1
(43) Pub. Date: Nov. 29, 2007

(54) Apparatus and Process for Producing Tubes or Rods

(76) Inventors: Ulrich Lange, Mainz (DE); Frank Thomas Lentes, Bingen (DE); Andreas Langsdorf, Ingelheim (DE); Christian Kunert, Mainz-Kastel (DE); Frank Buellesfeld, Frankfurt (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/574,734

(22) PCT Filed: Oct. 1, 2004
(86) PCT No.: PCT/EP04/10969

§ 371 Date: May 17, 2007

(30) Foreign Application Priority Data
Oct. 11, 2003 (DE) 103 48 098.6

(51) Int. Cl. C03B 17/04

(52) U.S. Cl. 65/439; 65/488; 65/494

(57) ABSTRACT

A process for producing tubes or rods is provided. The process includes providing a settable liquid and producing a strand by drawing the liquid from a nozzle in a drawing direction. The result of this is that the settable liquid emerges through an annular gap formed by the nozzle with the desired production throughput at the temperature which is above the devitrification temperature. The settable liquid cools as it flows down an outer and/or an inner surface of a displacement body so that, by the end of the displacement body, the settable liquid has a sufficiently high viscosity to be drawn in stable form at the desired production throughout without flowing more quickly than the drawing rate as a result of its own weight.

The invention relates to an apparatus and a process for producing strands in general and tubes or rods in particular by drawing a settable liquid, in particular a melt, from a nozzle as described in the preamble of claims 1 and 25.

Strands of settable liquids are made in particular for the production of rods or tubes. During the production of tubes from settable liquids, for example, and in particular during the production of glass tubes, high product qualities are important, depending on the particular application. Important quality requirements include maintaining the wall thickness and maintaining the external diameter of the tube. Furthermore, another important quality parameter is the constancy of the materials properties in the axial and radial directions of the tube. Furthermore, the surface quality is a crucial factor. It is desirable to obtain a fire-polished surface without noticeable traces.

Glass is a supercooled liquid which is in an amorphous, thermodynamically metastable state. Under certain conditions, virtually any glass is transformed into the corresponding thermodynamically stable crystalline form. The transformation into the crystalline form is also referred to in the context of glass as devitrification.

The tendency of a glass to crystallize differs considerably from glass to glass, however, and varies with the chemical composition of the glass. The tendency to crystallize can be influenced by varying the composition. At the same time, this also influences the other properties of a glass, which are often determined by the intended use of the glass. It is therefore often impossible to achieve a higher stability with respect to crystallization for a glass with a predetermined physical property profile.

The susceptibility to devitrification can be determined using various methods. It is customary for glass specimens to be brought into contact with the relevant shaping material and aged for different lengths of time at different temperatures. Tests are then carried out to establish under what time/temperature conditions crystals are formed and the size of these crystals are measured.

With regard to crystallization, a distinction is usually drawn as to the location in the specimen at which the crystals form. Bulk crystallization in the interior of the glass specimen is generally considerably delayed compared to crystallization at the surfaces of the specimen. The first crystallization generally takes place on contact between the edge of the specimen and the support material. As a result of the simultaneous presence of the three phases glass, support and atmosphere, crystallization is promoted there.

Above a certain temperature, which is referred to as the upper devitrification temperature or as the liquidus temperature, no crystals are formed even after prolonged ageing. Therefore, this temperature corresponds to the temperature which is of relevance during glass processing in order to decide on the question of whether or not crystallization is likely using certain processes.

In the case of glasses comprising a plurality of components, different devitrification limits often exist in the specimen depending on the relevant crystal phase and location of formation. For assessment, it is then necessary to take into account the devitrification limit which is of relevance to the particular process. In the case of glasses which are produced by drawing processes, this is generally the crystallization at the three-phase boundary.

The processes which are known for the production of glass rods can be divided into casting processes, in which the liquid glass is cast into casting molds which are closed or open at the bottom, and drawing processes, in which the glass, during shaping, cools without contact with a solid mold. These processes can be operated discontinuously or continuously.

One common feature of the casting processes is that the glasses are processed at high temperatures and low viscosities. As a result, it is possible to shape even glasses which are prone to crystallization and therefore do not permit especially long holding times at relatively low temperatures during shaping. Processes of this type are described, for example, in DD 154 359.

Discontinuous processes, in which closed molds are filled with glass, are generally used for small production quantities. The molds are then cooled together with the glass until the glass has solidified and can be demolded. The process can be used continuously by the mold being designed as a permanent mold which is open at the bottom and is generally cooled. The glass is introduced into the permanent molding liquid form, solidifies within the permanent mold and is drawn out at the bottom as a continuous strand which is divided into rods.

Advantages of these processes is that the glasses can be cast at very low viscosity, since the shape of the glass rods is formed by the casting mold during solidification. There if therefore no need for the glass to be inherently stable during shaping. This low shaping viscosity allows the processing even of glasses which are prone to crystallization in the event of slow cooling at relatively high viscosities.

One drawback of these processes is the generally very limited production throughput. Since the glass is introduced into the mold at a relatively high temperature and can only be removed at a low temperature after solidification, large quantities of heat have to be withdrawn from the glass, which even with intensive cooling of the mold is only possible for relatively slow processes. Moreover, the cooling must not take place too quickly, since otherwise the rod will break either while it is still inside the mold or, on account of the high thermal stresses, after it has left the mold.

A further drawback results from the direct contact of the glass with the mold during cooling. On account of the low shaping viscosity, even very small structures within the mold are reproduced on the surface of the rod, with the result that the surface structure of the mold is transferred to the rod. In addition, a characteristic wavy structure is formed on the surface as a result of the powerful cooling.

The requirement for a fire-finished surface cannot be satisfied in this way. Therefore, direct use of the rod in the as-produced state for example as a semi-finished product for optical components is not possible. The remachining of the rods by grinding and polishing entails high levels of effort and costs for the remachining and material wastage.

In addition to the mold-based processes, there are also further processes, in which rods are drawn freely without the use of a mold, i.e. without contact with a mold, out of a nozzle, in the form of a strand.

These processes assume that the glass can be cooled to a temperature corresponding to a viscosity of approximately 10⁶ dPa.s without crystallizing. Even with a prolonged production duration, the glass must not be prone to forming crystals in this temperature range.

A range which is particularly critical for the crystallization is the three-phase boundary at the underside of the nozzle, at which the liquid glass, the nozzle material and the surrounding atmosphere adjoin one another. Crystal formation preferentially occurs in this region, since the enthalpy of crystal formation is reduced there.

The high glass viscosity used when drawing compared to the viscosity used when casting is necessary to ensure that the high resistance to flow extension in the “draw bulb” prevents the glass from flowing down too quickly under its own weight. The draw bulb is the region of the strand which directly adjoins the last contact, as seen in the direction of flow, with the solid material, i.e. in particular the nozzle or the displacement body, in which the strand cross section may narrow in the drawing direction.

If the glass tends to flow down more quickly than the drawing rate under the influence of its own weight, the drawing process becomes unstable. It is then impossible to draw sufficiently straight rods, or the draw bulb may even break off.

Advantages of these free drawing processes is that they can be used to produce rods with fire-finished surfaces that can be used without remachining as semi-finished products for example for optical components for optical fibers.

Furthermore, these processes allow a production throughput which is often more than double that of the mold-based processes, and therefore significantly benefits production costs. Nozzle drawing processes of this type have long been known and are described, for example, in the publication by Günther Nölle entitled “Technik der Glasherstellung”, ISBN 3-342-00539-4, page 135 ff.

In addition to the processes with simple outlet nozzles, there are processes in which a displacement body is arranged within the outlet nozzle. This corresponds to the Vello process, which can be used to produce tubes and rods.

The central displacement body, which is usually fitted flush with the lower edge of the nozzle, increases the flow resistance in the nozzle and thereby allows higher drawing rates, which has a positive influence on the stability of the drawing process. As a result, slightly higher temperatures are possible at the lower edge of nozzle and displacement body.

Nevertheless, the viability of the free drawing processes is restricted to glasses which are not prone devitrification and crystal formation in the temperature-viscosity range required even over a prolonged period of time. Consequently, there is a very limited choice of glasses suitable for these shaping processes. In a range of glasses which in principle can be produced using these processes, crystals form after a certain time, with the result that production has to be interrupted in order to eliminate crystals from the shaping system again at a relatively high temperature. This leads to regular production down times and losses.

Processes for the production of flat glass with high surface qualities have been described for other glass shaping sectors, for example in DE 100 64 977. The objective of the process described in DE 100 64 977 is to allow deviations from the ideal surface contour to be annealed out.

To achieve high levels of planarity of the flat glass, during production the glass is kept as long as possible at a low viscosity, to enable deviations from the ideal surface contour as a result of the surface tensions to be annealed out. This takes place when the glass is flowing down the surface of the displacement body used there. Accordingly, the glass should as far as possible not cool down on the displacement body, in order to maintain its low viscosity.

Extremely rapid cooling takes place below the end of the displacement body, with the result that the glass ribbon can be drawn in stable form. However, this rapid cooling is only possible for the thin glass ribbon thicknesses of less than 3 mm described in DE 100 64 977; in this case, however, there is only a very small mass of glass present in the region of the draw bulb.

In the case of glass rods or tubes with a diameter of over 15 mm and usually even over 25 mm in the case of rods or with a wall thickness of over 5 mm in the case of tubes, this rapid cooling of the glass is not possible directly beneath the draw bulb.

The susceptibility to crystallization rises with increasing demands imposed for glasses which have been newly developed in recent times. At the same time, there is also a desire for it to be possible for glasses of this type to be drawn “freely”, in order to maintain the high production throughput and to obtain rods or tubes with a good surface condition.

What are known as down-draw processes and the Vello process are known for the production of glass tubes. The Vello process is a special vertical drawing process for glass tubes, in which a melt is drawn down out of an annular nozzle and is then diverted into the horizontal. This produces a tube of liquid glass which sets as the process continues.

The glass melt is usually fed to the nozzle via a feeder. At the base of this feeder there is a cylindrical opening comprising the annular nozzle, through which the glass melt can flow out via a vertical cone. The vertical cone can in particular be vertically adjustable and widened in a funnel shape in the downward direction.

The cone is hollow and connected by an extension tube to a source for what is known as the blowing air. The desired external diameter/wall thickness ratio is set by the blowing air which is introduced into the interior of the tube of liquid glass which forms at the annular nozzle. The tube is then drawn downward into a temperature-controlled shaft. Subsequently, the tube, either hanging freely or with the aid of a guide, can be diverted into the horizontal and drawn onward by a drawing machine.

The down-draw processes differ from the Vello process by virtue of the fact that the tube is not diverted into the horizontal, but rather is drawn directly vertically downward.

In the processes mentioned, the shaping tool for producing the tube substantially comprises a circular nozzle, into which a cylindrical or conical needle is fitted substantially concentrically. The glass melt flows out vertically downward from the annular gap between the needle and the edge of the nozzle, so that a hollow glass strand is formed beneath the needle. This glass strand is cooled in a controlled way and ultimately drawn continuously as a tube by a drawing machine at a certain distance from the nozzle.

The external diameter and wall thickness of the tubes produced in this way can be adjusted by suitable adjustment of the glass throughput, the drawing rate and the needle position in the nozzle. The range of external diameters and wall thicknesses which can be achieved can be considerably widened by producing a pressure difference between the interior of the tube and the area surrounding the tube.

However, the processes mentioned have the drawback that the viscous glass strand, at low viscosities, tends to flow down under its own weight more quickly than it is drawn by the drawing machine, resulting in unacceptable fluctuations in the geometry of the glass strand.

This means that the known processes have the drawback that the required high product quality cannot be reliably maintained below a certain glass viscosity. This prevents stable production of a tube geometry which is as accurate as possible.

One possible countermeasure is to increase the drawing rate. However, on account of mass conservation, this measure is restricted by the fact that the glass throughput then likewise has to be increased in order to keep the tube geometry constant. However, on account of the preceding (melting down, refining, homogenizing) and following (cooling and cutting) steps of processing the glass, the glass throughput is limited.

In addition to increasing the drawing rate, the difference between the rate at which the glass strand flows down under its own weight and the drawing rate can be reduced by drawing at lower temperatures, i.e. higher glass viscosities. However, if the temperature is reduced considerably, crystals can form in the glass melt. The formation of crystals is extremely detrimental to the homogeneity of the glass tube in particular with regard to product properties. In particular the three-phase boundaries between glass, air and nozzle or needle material are at particular risk as a result.

When producing glass tubes by drawing in the manner described above, moreover, small waves may form on the free surface of the glass melt during drawing from the nozzle. If the glass viscosity is increased by lowering the temperature, these small waves on the free surface of the glass are annealed out considerably more slowly. This means that drawing at lower temperatures, i.e. higher glass viscosities, in addition to the formation of crystals, is also prone to a significant deterioration in surface quality and wall thickness constancy of the glass tube.

Therefore, it is an objective of the invention to provide a process which allows settable liquids, in particular glasses, which are prone to the formation of crystals in the temperature/viscosity range of the standard free rod or tube drawing, to be produced continuously over a prolonged period of time as rods or tubes with fire-finished surfaces without any interruptions to production caused by crystallization.

The circumstances described above therefore result in the object of the invention of providing an apparatus and a process which allow stable production of a strand from a viscous settable liquid with an accurate geometry and a high surface quality.

The term “strand” is to be understood as meaning bodies which, in fundamentally any desired cross section, can be produced with a large dimension in a direction perpendicular to this cross section compared to the dimensions of the cross section and may consist of a settable liquid. The material may already be solid, or alternatively may be partially set or still liquid.

In particular, the strand can be used to produce at least one rod. The strand may be hollow, with the result that at least one tube can also be produced from the strand. A plurality of tubes or rods can be produced as sections of the strand.

The terms “tube” or “rod” are to be understood as meaning bodies which have a circular, oval, elliptical or polygonal cross section in a plane perpendicular to their longitudinal axes.

A further object of the invention is to allow the product and operating parameters to be selected freely substantially without influencing the predetermined throughput, so that the throughput continues to be available as an independent parameter.

For this purpose, in particular the formation of crystals in the viscous liquid, in particular glass melts, should be substantially ruled out. A further object of the invention is to promote the annealing out of irregularities, in particular of small waves on the free surface of the glass melt when the strand is being formed.

These objects are achieved, in a very surprisingly simple way, by the apparatus having the features of claim 1. Furthermore, claim 31 describes a process which achieves the objects described above. Advantageous refinements are to be found in the respectively associated subclaims.

The solution according to the invention therefore for the first time provides an apparatus for producing tubes by drawing settable liquids, in particular melts, out of a nozzle in a drawing direction, which apparatus has at least one displacement body which can be arranged in such a manner in the nozzle that it projects out of the nozzle in the drawing direction. The displacement body serves on the one hand to increase the flow resistance within the nozzle and on the other hand to stabilize the direction of flow and the controlled cooling of the material on leaving the nozzle.

The inventors have discovered that stable production of a tube geometry which is as accurate as possible can surprisingly be ensured simply by the free glass strand being under tensile stress from the end of the displacement body to the drawing machine. This tensile stress has to be kept stable over the entire length of the strand.

The tensile stress within the strand results mainly from the difference in tensile force resulting from the drawing and the force of the weight acting on the strand. The tensile force is transmitted by the viscous resistance to extending flow in the draw bulb. The low glass temperature in the draw bulb which is required to achieve a sufficiently viscous resistance can be set, in the solution according to the invention, by the controlled cooling during the flow onto or around the displacement body.

The apparatus, which comprises the displacement body, advantageously provides a drawing tool which is designed in such a way that the temperature is above the upper devitrification limit substantially at all the locations at which a three-phase boundary forms between settable liquid, material of the nozzle and the surrounding gas. The term “displacement body” is to be understood as meaning that part of the apparatus on whose surface the settable liquid runs down, with the formation of a three-phase interface in the temperature range critical to crystallization being completely avoided.

Since the film flow on the displacement body is very slow on account of the sticking condition, the glass can be cooled considerably over just a relatively short distance.

The critical location with regard to the crystallization of the settable liquid is usually the lower edge of the nozzle, since relatively low temperatures are often present there. Glasses which are critical in terms of crystallization, however, at these temperatures of their upper devitrification limit, have viscosities which are too low to allow them to be drawn freely. The draw bulb which forms would no longer be held by the viscous forces within the glass, would consequently become instable and ultimately break off under its own weight.

As a result of the provision of a displacement body which projects out of the nozzle in the drawing direction, it is possible to decouple the region of the three-phase boundary line and the region where the strand is detached from the apparatus. This means that in the region of the three-phase boundary line of first contact between the settable liquid and the surrounding gas during drawing in the drawing direction, the temperature can be kept high and the viscosity low. In the region where the strand is detached from the apparatus, i.e. from the lower boundary of the displacement body, the temperature can be selected to be lower and therefore the viscosity higher.

The invention therefore advantageously simultaneously allows the processing of glasses at a sufficiently high viscosity in the region of the draw bulb, yet nevertheless the temperature at the three-phase interface may be above the upper devitrification temperature.

The invention advantageously provides that the displacement body projects out of the nozzle in the axial direction by at least half the shortest dimension of its cross section, in order to make available the widest possible range for decoupling the region of the three-phase boundary line and the region where the strand is detached from the apparatus and at the same time to ensure sufficient stability of the arrangement. In general, the displacement body may have any desired geometries. In the case of a circular cross section, according to the invention the displacement body projects out of the nozzle for example by at least a length corresponding to half its diameter.

To allow the strand to be detached from the displacement body as homogenously as possible, the boundary of the displacement body (16, 25) arranged outside the nozzle can end in a virtually pointed tip or a sharpened edge.

Furthermore, the invention provides for the nozzle to comprise an outer shell, of which the boundary that is in contact with the strand is designed in such a manner that the strand becomes detached from the nozzle at a defined breaking edge. As the inventors have discovered, this advantageously reduces crystallization at the three-phase interface still further.

In one embodiment of the invention, the boundary of the outer shell of the nozzle which is in contact with the strand may include a material which is poorly wetted and preferably not wetted at all by the settable liquid. Consequently, there is a low likelihood of crystals being formed, since the holding time is shortened if the material is poorly wetted by the settable liquid in the range of high nucleation rates, namely in particular in the region of the three-phase interface.

In an advantageous refinement, according to the invention, the boundary of the outer shell of the nozzle which is in contact with the strand can be microstructured. This microstructure can, for example, influence the wetting according to the Lotus effect, in such a manner that the settable liquid scarcely wets the nozzle material in particular in the region in which the strand becomes detached from the nozzle.

To allow the displacement body to be positioned in the nozzle, it is possible for connecting elements to be provided for connecting the displacement body to the nozzle. In particular with a view to minimizing the influencing of the flow resistance by the connecting elements, according to the invention the displacement body is connected to the nozzle from above. It is preferable, however, for the displacement body to be variably positioned within the nozzle, for example by means of a holder which runs upward, so that the horizontal and vertical positions of the displacement body can be adjusted in operation. This allows adaptation to production and material fluctuations.

According to the invention, the displacement body can be arranged within the outer shell of the nozzle. This embodiment of the invention allows the production of rods.

In accordance with the invention, the displacement body may also comprise an inner hollow body which is open with respect to the surrounding settable liquid and may be arranged between the outer shell of the nozzle and a needle. This embodiment of the invention allows the production of tubes.

Two contact surfaces, namely the inner surface and the outer surface of the hollow body, to which the settable liquid sticks after it has emerged from the nozzle and is thereby subject to frictional force, are made available in a simple way by an open hollow body positioned between the outer shell and the needle in the nozzle.

On emerging from the nozzle, both the inner surface of the tube to be produced and its outer surface are free, i.e. are not in direct contact with solid walls. As a result, unevenness on the surfaces of the inner and outer walls of the tube can be annealed out equally well.

The invention also provides for the nozzle to have a cylindrical outer shell in order to allow the production of tubes and rods with a circular cross section.

According to the invention, the displacement body (16, 25) and/or the needle may advantageously likewise be of cylindrical design. According to one embodiment, the displacement body is arranged coaxially with respect to the nozzle and/or the needle.

The invention advantageously offers the possibility of providing a displacement body which is in each case optimally geometrically matched to the demands imposed on the quality of the inner surface of the tube and/or the outer surface of the tube or strand.

On account of the friction at the displacement body, the velocity on emerging from the nozzle is significantly lower than in the free strand in the conventional processes, for as long as the liquid is still in contact with the displacement body.

During the residence time of the settable liquid on the displacement body, the liquid can cool between the nozzle outlet and the end of the displacement body. In particular, the temperature of the liquid at the nozzle can be kept at a sufficiently high level for no crystallization to occur, for example at the three-phase boundary line. At the same time, a sufficiently high viscosity for the free strand to be under tensile stress throughout is nevertheless set at the lower end of the device.

The invention therefore advantageously allows a crystallization-free, stable drawing process. Furthermore, the invention offers the advantage that during the slow flow on the displacement body, unevenness in the free glass surfaces can be annealed out in particular by surface tension effects.

The invention therefore offers the major advantage of allowing the production of tubes and rods of improved surface quality.

The displacement body according to the invention gives rise to a further parameter for controlling the throughput of the settable liquid independently of temperature. The temperature and therefore the viscosity of the strand, given a suitable geometric design and setting, can be adjusted to values which would not allow a stable process management to be implemented in a drawing process without a displacement body, while at the same time the same throughput can be set as in the process without a displacement body.

In an advantageous refinement, therefore, it is provided that the dimensions of the displacement body and of the nozzle are matched to one another in a plane perpendicular to their longitudinal axes, in such a manner that the flow resistance of the gap between nozzle and displacement body permits a predeterminable throughput at the given viscosity of the settable liquid.

The invention furthermore provides that the displacement body can be designed in such a manner that its dimensions are not constant in a plane perpendicular to its longitudinal axes. The gap of the nozzle can preferably be varied by adjusting the displacement body in order to adapt the throughput to the production requirements.

According to the invention, said parameters can also be influenced by a device for adjusting and/or controlling and/or regulating the throughput of the settable liquid. The throughput of the settable liquid corresponds to the throughput of the strand and therefore to the production rate. It is easy to adapt to upstream or downstream components of the overall installation by adjusting and/or controlling and/or regulating the throughput of the settable liquid.

Furthermore, the apparatus according to the invention provides for a device for controlling the temperature of the outer shell and/or of the displacement body. This advantageously also allows the temperature of the strand and in particular of that part of the displacement body which projects out of the nozzle as well as the draw bulb to be controlled.

The temperature-control device provided may in particular be a muffle, which may be arranged beneath the nozzle. The controlling of the temperature of the abovementioned components can influence the viscosity of the liquid in an advantageous way in this region.

As well as by a surrounding muffle, the temperature of the displacement body and in particular of that part of the displacement body which projects beneath the nozzle can be controlled in other ways, for example in addition to the temperature control by means of the muffle. By way of example, direct electrical heating or contactless inductive heating can be provided for this purpose. As a result, the temperature of in particular the lower part of the displacement body can be set in a targeted way. In particular, control of the temperature of the displacement body independently of the muffle temperature, which mainly affects the temperature of the covering of settable liquid on the displacement body, is possible.

According to the invention, the temperature-control device comprises at least one temperature-control element, the position of which can be adjusted variably. Therefore, the invention advantageously offers the possibility of altering the temperature of the settable liquid and/or of the strand in a targeted, locally-based way.

In particular, the temperature-control device may comprise at least two temperature-control elements which are independent of one another. Therefore, the invention makes it possible to realize a segmented structure of the apparatus in the circumferential and drawing directions, so that a desired temperature profile becomes possible, in particular for setting predeterminable cooling and/or heating kinetics.

To allow the desired temperature profile to be adapted to changing materials and operating parameters, the invention advantageously provides for a device for adjusting and/or controlling and/or regulating the temperature of the outer shell and/or of the displacement body. The temperature profile can be influenced in particular as a function of the temperature of the strand, in particular in the region of the draw bulb.

To advantageously provide additional cooling of the strand, the apparatus comprises, in an advantageous refinement, a device for applying a liquid, in particular by spraying, to the strand, in particular to the draw bulb. The enthalpy of vaporization of the applied liquid, which is withdrawn from the settable liquid, extracts heat from the settable liquid and thereby allows more extensive cooling of the strand.

To protect the apparatus according to the invention and in particular the displacement body from damage caused by high temperatures, the invention advantageously provides for the apparatus and in particular the displacement body to comprise a temperature-resistant material. The temperature resistance can be realized in a simple way by the displacement body comprising at least one high-melting metal and/or a precious metal, in particular platinum, and/or at least one refractory metal and/or at least one alloy thereof and/or ceramic.

For the production of tubes, the apparatus according to the invention also comprises a device for generating a pressure difference between the interior and exterior of the strand.

Therefore, the invention advantageously offers the option of using a pressure difference between the interior and exterior of the strand to make available a further process parameter which can be used to influence the internal diameter, the wall thickness and the external diameter of the tube.

Furthermore, the invention provides for making available a device for adjusting and/or controlling and/or regulating the pressure in the interior and/or the pressure in the exterior of the strand. In this way, the pressure difference can advantageously be variably adapted to different requirements and can in particular also be altered during operation.

The solution according to the invention for the first time provides a process for producing tubes which comprises the steps of providing a settable liquid, in particular a melt, and producing a strand by drawing out of a nozzle in a drawing direction, it being possible for higher temperatures to be achieved in the nozzle in particular by arranging at least one displacement body in the nozzle in such a manner that it increases the flow resistance in the nozzle and projects out of the nozzle in the drawing direction than without the use of a displacement body, which temperatures are in particular above the critical crystallization temperatures, and at the same time at the end of the displacement body the viscosity of the liquid is sufficiently high for it to be possible to absorb the tensile force required for a stable process.

During the residence time of the strand in the region of that part of the displacement body which projects out of the nozzle, it is possible to deliberately lower the temperature of the liquid. With known process and materials parameters, this residence time can be varied by altering the geometry of the displacement body. This provides the option, as described above, of keeping the temperature high and the viscosity low in the region of the three-phase boundary line yet nevertheless providing sufficient time for subsequent cooling in order to allow the temperature to be selected to be lower and the viscosity therefore higher in the region where the strand is detached from the apparatus.

For the process according to the invention, it is advantageously also provided that the dimensions of the displacement body and of the nozzle are adapted to one another in a plane perpendicular to their longitudinal axes, in such a manner that the flow resistance of the gap between nozzle and displacement body allows a predeterminable throughput at the given viscosity of the settable liquid.

The diameter of the displacement body and of the nozzle can in particular be adapted to one another in such a manner that the flow resistance of the annular gap formed from nozzle and displacement body, at the temperature which is above the devitrification limit and the viscosity which is set as a result, allows a flow throughput which corresponds accurately to the production throughput of the process. The annular gap can preferably be varied by adjusting the displacement body in order to adapt the throughput to the production requirements.

For the process, the invention also provides for the position of the displacement body to be adjusted perpendicular to the drawing direction and in the drawing direction. As a result, the invention makes it possible in a simple way, with an otherwise unchanged geometry of the installation used, to carry out corrections and in particular to influence the residence time of the liquid on that part of the displacement body which projects out of the nozzle, with the result that, together with the ambient temperatures prevailing in this region, it is possible to influence the temperature difference which is established between the region of the annular gap at the lower end of the nozzle and the region where the strand is detached from the lower end of the displacement body.

In an advantageous refinement of the process, the length of that part of the displacement body which projects out of the nozzle is set in such a way, by the positioning of the displacement body, that the settable liquid, at the end of the displacement body which projects out of the nozzle, has a viscosity which is sufficiently high to keep the entire strand under tensile stress and therefore stable.

Moreover, within the context of the process, it is possible to adjust and/or control and/or regulate the temperature of the outer shell and/or of the displacement body. Therefore, the invention offers the possibility of influencing the temperature and therefore, for example, the viscosity of the settable liquid. In particular a muffle can be used to control the temperature of the outer shell and/or of the displacement body. It is preferable for this muffle to include at least two segments in the circumferential direction or drawing direction, the temperatures of which segments can be adjusted separately.

It is particularly advantageous if the temperature of the settable liquid can be varied temporarily and also locally over the course of the process. In this case, the temperature profile of the settable liquid and/or of the strand can be predetermined with a view to cooling and/or heating kinetics.

The invention advantageously also provides for the temperature surrounding the strand to be adjusted in such a way that the settable liquid at the lower end of the displacement body has a viscosity, in particular a mean viscosity over the cross section, which is sufficiently high to keep the entire strand under tensile stress and therefore stable.

By way of example, the apparatus according to the invention can be designed on the basis of the temperature-dependent viscosity in accordance with the Vogel-Fulcher-Tamann equation.

The temperatures prevailing at the lower end of the displacement body can be below the devitrification limit. In this case, crystallization would be likely if a three-phase boundary were present. However, since the invention means that the position of the three-phase boundary is not at the lower end, but rather in a region of the displacement body which is closer to the nozzle outlet, with correspondingly higher temperatures, it is advantageously the case that crystals are still not formed, in particular at the surface of the strand.

The temperature profile can in this case advantageously be configured in such a manner that the feed and setting of the strand are optimized with a view to the resulting product properties. In this respect, it is particularly advantageous if, in the context of the process according to the invention, the position of at least one temperature-control element is adjusted and/or controlled and/or regulated.

Moreover, the invention advantageously provides for a liquid to be applied, in particular by spraying, to the strand, in particular in the region of the draw bulb. This creates the option of realizing additional cooling of the strand.

In order to be able to influence the internal diameter and/or the wall thickness and/or the external diameter of a tube which is to be manufactured during the production of tubes with a constant throughput and an unaltered installation, the process according to the invention offers a simple way of generating a pressure difference between the interior and exterior of the strand.

To allow the process, for example, to be adapted to changing materials properties, moreover, the invention provides for the pressure in the interior and/or exterior of the tube to be adjusted and/or controlled and/or regulated.

Moreover, according to the process according to the invention, the throughput of the settable liquid can advantageously be adjusted and/or controlled and/or regulated. Depending on how the process according to the invention is carried out within the context of the specific procedure employed, therefore, it is possible to influence the production rate via the additional independent process parameter of the throughput.

The settable liquid used may in particular be a glass melt. It is also possible to process glass melts which are obtained as amorphous rods or tubes by the process according to the invention but are then converted into a glass-ceramic by targeted bulk crystallization, for example by means of a temperature treatment.

The apparatus and/or process according to the invention for the first time make it possible to produce a rod or tube from a material, for example glass, which would usually crystallize during production but with the aid of the invention is substantially free of crystallization in particular at the surface and has substantially no unevenness at the free surfaces.

In particular, the surface on the inner side of the tube and/or the surface on the outer side of the tube or rod has a fire-polished quality.

Furthermore, the invention relates to a glass-ceramic rod or a glass-ceramic tube, the glass-ceramic in particular comprising Zerodur, which has been produced from a rod or a tube that has been manufactured using the invention.

Furthermore, the invention comprises a lens which has been produced from a rod that has been manufactured using the invention.

The invention also relates to a fiber, in particular an optical fiber, which has been produced from a tube and/or a rod manufactured using the invention.

The invention is described below on the basis of exemplary embodiments and with reference to the accompanying drawings. The same components are denoted by the same reference designations throughout all the drawings, in which:

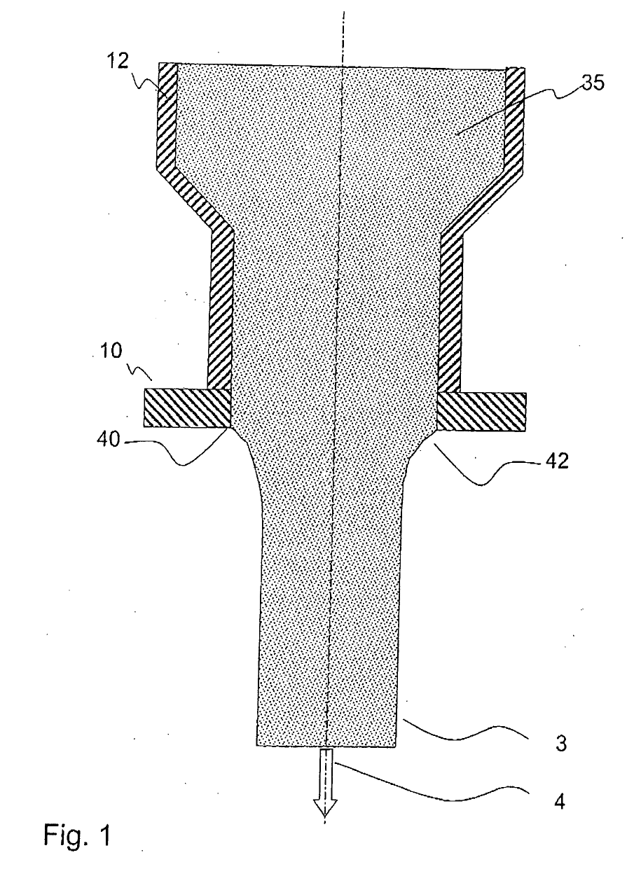

FIG. 1 diagrammatically depicts a longitudinal section through an apparatus for free strand drawing in accordance with the prior art,

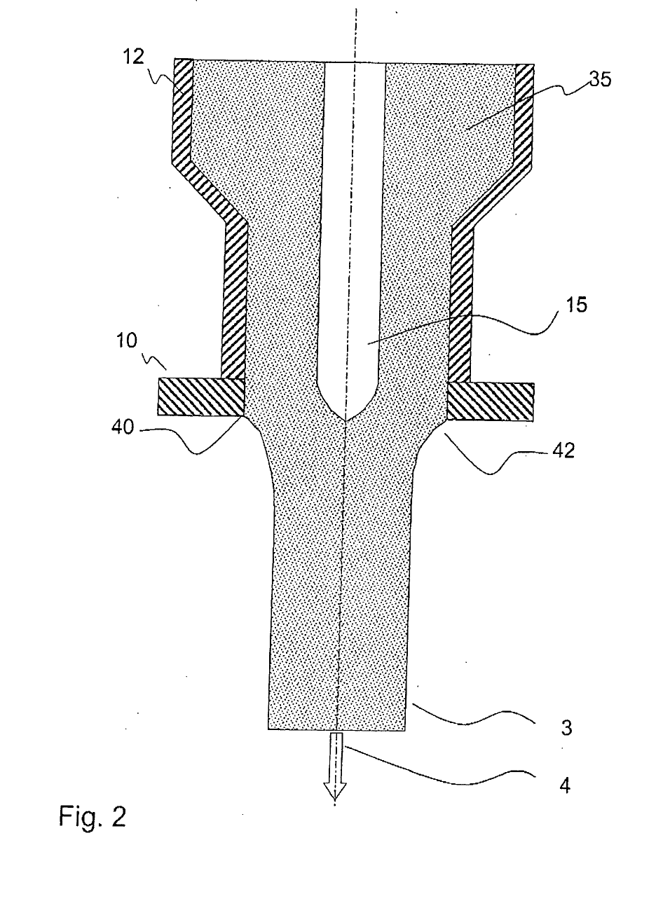

FIG. 2 diagrammatically depicts a longitudinal section through a second apparatus for strand drawing in accordance with the prior art,

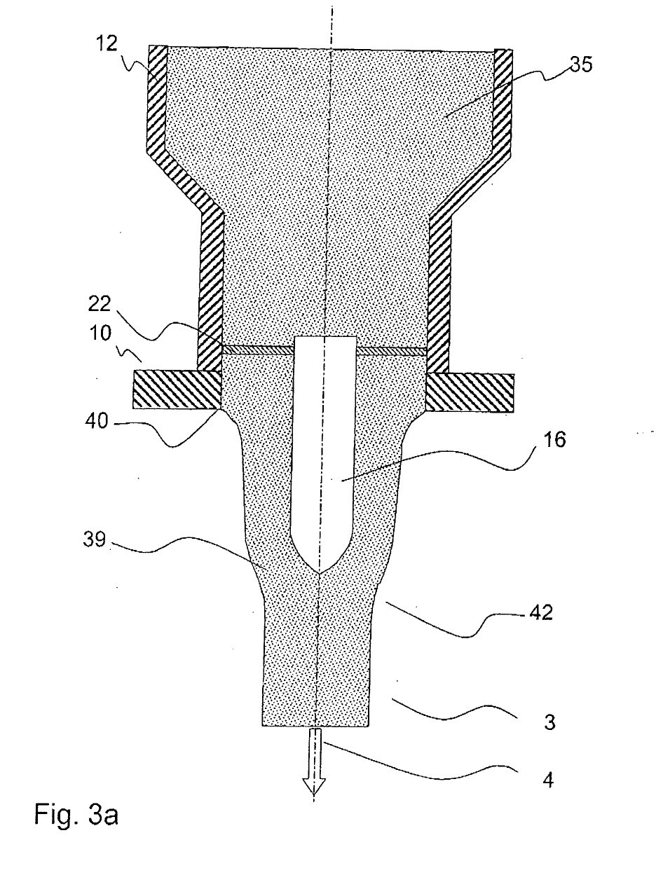

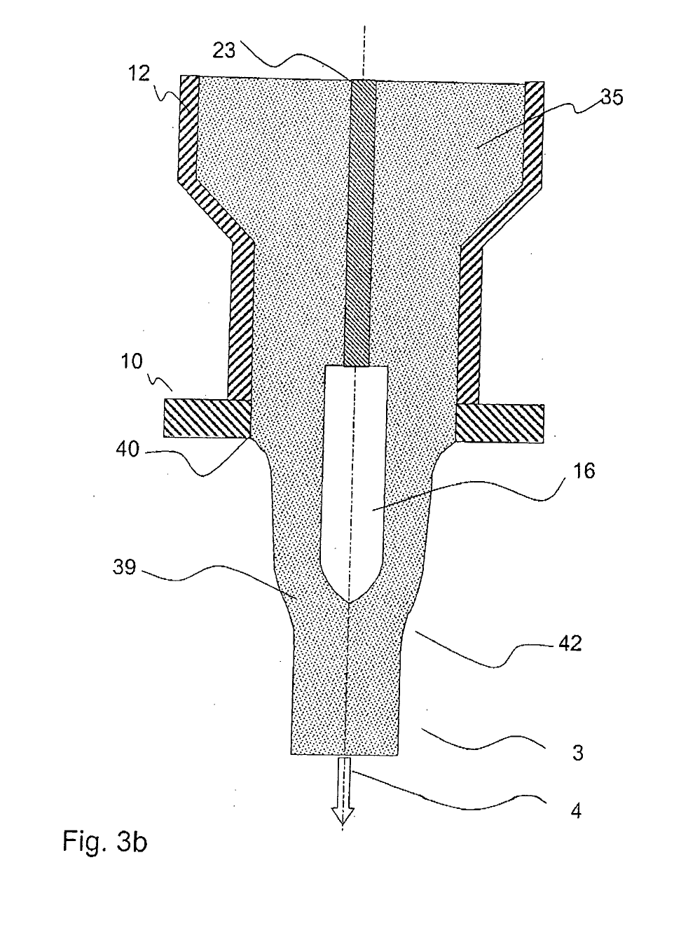

FIG. 3a diagrammatically depicts a longitudinal section through a first exemplary embodiment of the apparatus according to the invention,

FIG. 3b diagrammatically depicts a longitudinal section through a second exemplary embodiment of the apparatus according to the invention,

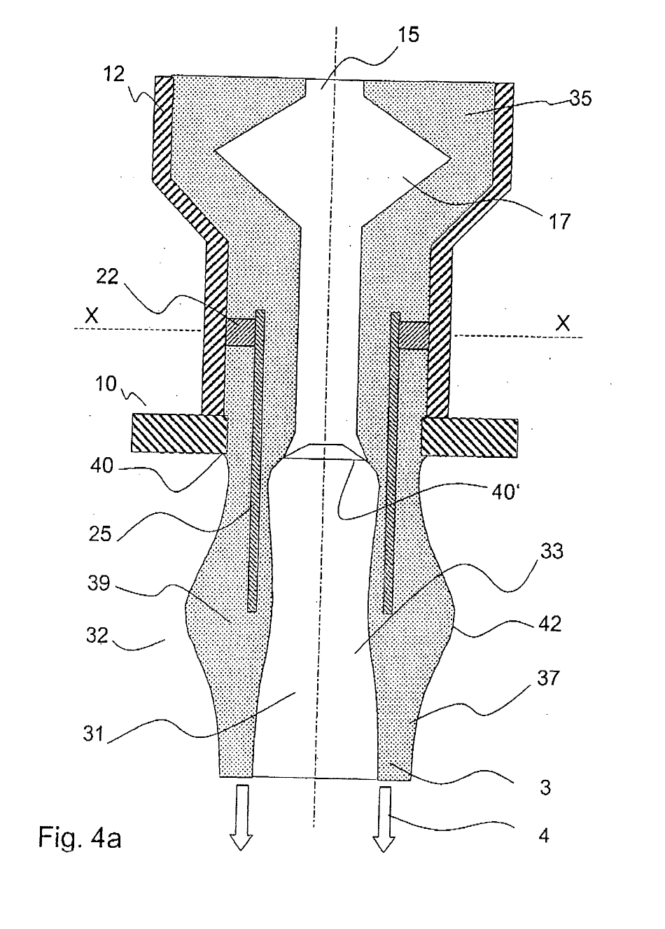

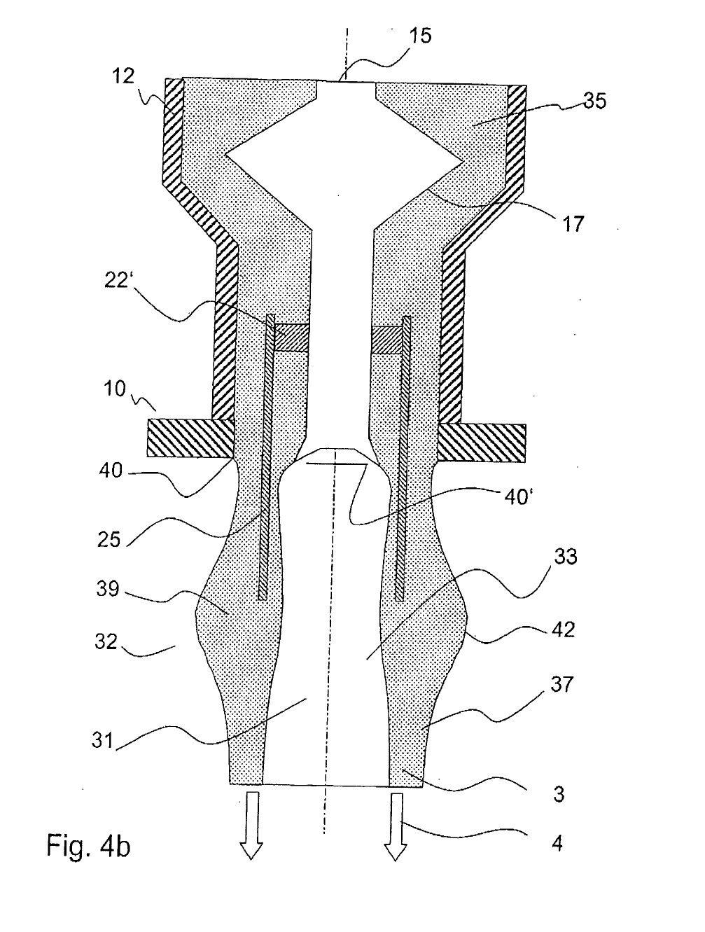

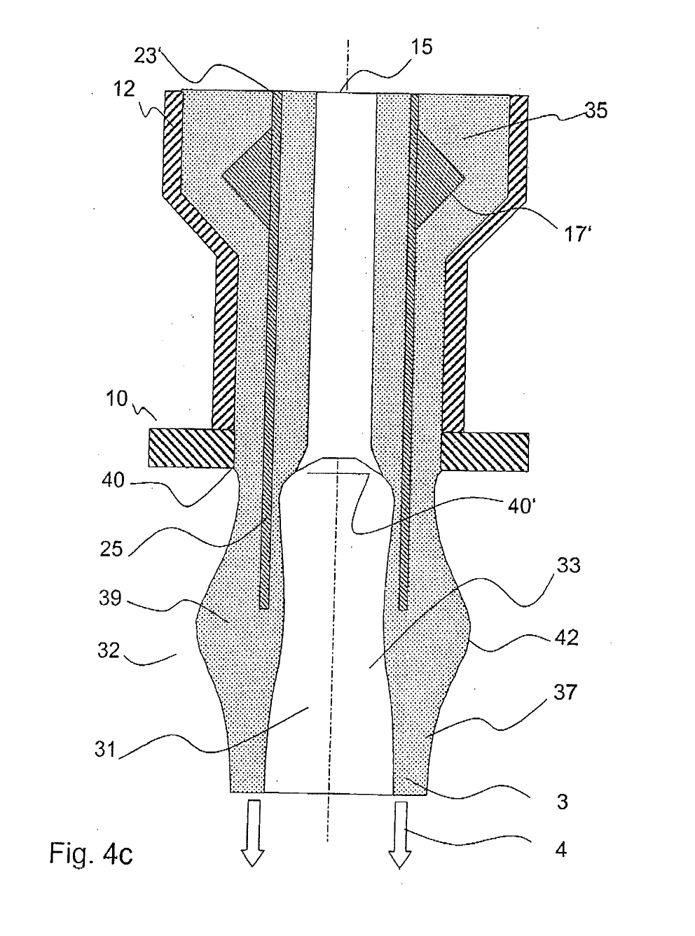

FIG. 4a diagrammatically depicts a longitudinal section through a third exemplary embodiment of the apparatus according to the invention,

FIG. 4b diagrammatically depicts a longitudinal section through a fourth exemplary embodiment of the apparatus according to the invention,

FIG. 4c diagrammatically depicts a longitudinal section through a fifth exemplary embodiment of the apparatus according to the invention,

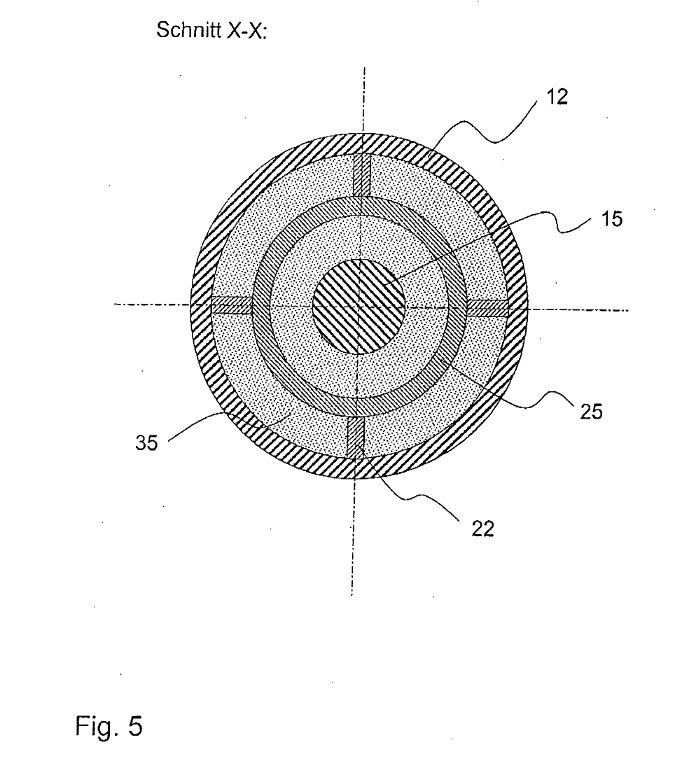

FIG. 5 diagrammatically depicts a cross section in plane X-X through the apparatus illustrated in FIG. 4a corresponding to the third exemplary embodiment.

FIG. 1 illustrates an apparatus having a nozzle 10 which can be used to carry out a known process for the production of rods. The nozzle 10 comprises an outer shell 12. A settable liquid 35 is located within the nozzle. According to the prior art, a rod is drawn without a mold “freely”, i.e. without contact with a mold, in the form of a strand 3 out of a nozzle 10.

FIG. 2 shows a further apparatus for strand drawing in accordance with the prior art. It likewise comprises a nozzle 10 with an outer shell 12. The arrangement illustrated corresponds to a down-draw process. A needle 15 is arranged in the nozzle 10. The needle 15 is fitted flush with the lower edge of the nozzle 10. It increases the flow resistance in the nozzle 10, so that slightly higher temperatures are possible at the lower edge of the nozzle.

However, since when using this arrangement the region of the three-phase boundary 40 and the region 42 where the strand is detached from the nozzle are coupled to one another, crystals may form, with the result that production has to be interrupted.

The known processes in particular require a relatively high viscosity in order to prevent the strand 3 from flowing down too quickly under its own weight. This means that the temperature in the region 42 in which the strand 3 becomes detached from the nozzle 10 has to be correspondingly low. However, as the temperature decreases, the susceptibility to devitrification of the settable liquid 35 rises and this liquid begins to crystallize. The crystallization preferentially takes place at the three-phase interface 40. The region of detachment 42 and the three-phase interface 40, however, are linked to one another according to the prior art.

FIG. 3a shows a first embodiment of the apparatus according to the invention, having a nozzle 10, at least one displacement body 16 and a strand 3, which forms a rod. The nozzle 10 comprises an outer shell 12 and a displacement body 16.

Unlike in the prior art, the displacement body 16 projects a long way out of the nozzle 10. In the illustration shown in FIG. 3a, the displacement body 16 is connected to the outer shell 12 using connecting elements 22.

The settable liquid 35 is located in the nozzle 10 between the outer shell 12 and the displacement body 16. At the outlet of the nozzle 10, the settable liquid 35 leaves the nozzle, resulting in the formation of a strand 3 which is drawn in a drawing direction 4.

The region 42 where the strand 3 is detached is decoupled from the three-phase boundary 40 as a result of the use of the displacement body 16. As a result, a temperature at which the crystallization of the settable liquid 35, in particular on the surface of the strand 3, is reliably avoided can be set in the region of the three-phase boundary 40.

During the residence time of the settable liquid 35 on the region of the displacement body 16 which projects out of the nozzle 10, however, the arrangement according to the invention offers the possibility of the settable liquid 35 cooling to such an extent that when it reaches the detachment region 42 it is at a sufficiently low temperature to allow stable drawing.

FIG. 3b illustrates a second embodiment of the apparatus according to the invention. This embodiment differs from FIG. 3a by virtue of the fact that the displacement body 16 is not fixed to the outer shell 12 of the nozzle, but rather can be adjusted horizontally and vertically within the nozzle 10 by means of a holder 23. As a result, adjustments can also be carried out while the process is still running.

FIG. 4a shows a third embodiment of the apparatus according to the invention, having a nozzle 10, a displacement body 25 in the form of an open hollow body, and a strand 3 which forms a tube. The nozzle 10 comprises an outer shell 12 and a needle 15. The settable liquid 15 is located in the nozzle 10 between the outer shell 12 and the needle 15. At the outlet of the nozzle 10, the settable liquid 35 leaves the nozzle as a hollow strand 3, resulting in the formation of a tube which is drawn in a drawing direction 4.

According to the third embodiment, the displacement body 25 comprises a cylindrical hollow body which is connected to the nozzle 10 between the outer shell 12 and the needle 15. In the illustration presented in FIG. 4a, the displacement body 25 is connected to the outer shell 12 by connecting elements 22. As illustrated in FIG. 4b, the displacement body 25 may, however, also be connected to the needle 15. It is also possible for the displacement body 25, as illustrated in FIG. 4c, to be held independently of outer shell and needle by means of a holder 23′. This allows horizontal and vertical displacement of the displacement body and therefore adjustment while the process is still running. The holder 23′ is interrupted in the circumferential direction, so that the settable liquid can also penetrate into the space between the holder 23′ and the needle 15.

A pressure difference can be set between the interior 31 and the exterior 32 of the hollow strand 3. By way of example, the wall thickness of the hollow strand 3 can be influenced by the pressure difference between the interior 31 and the exterior 32.

The use of the displacement body (25) decouples the detachment region 42 of the hollow strand 3 from the three-phase interface 40. As explained above for the first embodiment of the invention for the production of a rod, it is in this way possible to set a temperature at which the crystallization of the settable liquid 35, in particular on the inner and/or outer surface of the strand 3, is reliably avoided, in the region of the three-phase interface 40.

During the residence time of the settable liquid 35 on the surfaces of the displacement body 25, which projects out of the nozzle 10, however, the arrangement according to the invention offers the possibility of cooling the settable liquid 35 to such an extent that when it reaches the detachment region 42 it is at a sufficiently low temperature to allow stable drawing.

FIG. 5 illustrates, by way of example, how the displacement body 25, which is in the form of a hollow body, may be arranged in the apparatus according to the third embodiment of the invention. The displacement body 25 is mounted in the outer shell 12 by means of a plurality of connecting elements 22. The needle 15 is arranged coaxially with respect to the outer shell 12. The settable liquid 35 is located between the outer shell 12 and the displacement body 25 and between the displacement body 25 and the needle 15.

By way of example, an apparatus according to the invention can be designed in the following way for a given glass. An exemplary glass having the following properties is considered: The temperature dependency of the viscosity ç (in dPa.s) can be described using the parameters A, B and T₀ according to the Vogel-Fulcher-Tammann equation. The following relationship applies
log ç=A+B/(T−T₀),
where A=−4.16; B=5156 K and To=263 K.

The upper devitrification limit is 1010° C. The density of the glass is 3400 kg/m³. The surface tension is 0.3 N/m. The active thermal conductivity within the glass is 3 W/(mK). The specific heat capacity of the glass is 1000 J/(kg.K).

For the example under consideration, it is assumed that a muffle in which there is a constant temperature of 500° C. adjoins the bottom of the nozzle. The production throughput of the process is to be 72 kg per hour.

For stable production operation without interruption due to crystallization, it is necessary for the coldest point at which a three-phase boundary occurs to be kept at at least 1020° C. and therefore above the devitrification limit.

Using conventional mathematical simulation software to calculate flow patterns, it is possible to determine suitable geometric dimensions for the outlet nozzle and the displacement body. In the example under consideration, the outlet nozzle and displacement body are circular in cross section. In addition to its dimensions, the length of the displacement body is also determined.

The dimensions are fixed in such a way that the glass, when it is flowing along the displacement body, cools down to a temperature which is sufficiently low to allow it to be drawn freely in a stable way.

This results, for example, in a nozzle diameter of 160 mm, a displacement body diameter of 140 mm, and a length of the displacement body which projects beneath the nozzle of 170 mm, of which 100 mm is in the form of a cylindrical part and 70 mm in the form of a conical part. As a result, the boundary of the displacement body projecting out of the nozzle has a pointed tip.

An apparatus dimensioned in this way enables the glass to emerge through the annular gap formed from nozzle and displacement body with the desired production throughput at the temperature which is above the devitrification temperature. The glass cools down as it flows down along the outer surface of the lower part of the displacement body. At the end of the displacement body, the glass then has a sufficiently high viscosity to enable it to be drawn stably with the desired production throughput without flowing down under its own weight more quickly than the drawing rate.

1-43. (canceled)

44. An apparatus for producing hollow strands by drawing at least one settable liquid in a drawing direction, comprising:
a nozzle having an outer shell and a needle, said nozzle extending in the drawing direction; and
at least one displacement body projecting out of the nozzle in the drawing direction, wherein said at least one displacement body comprises a hollow body that is open with respect to the at least one settable liquid, said hollow body being arranged in said nozzle between said outer shell and said needle, said hollow body projecting out of said nozzle in the drawing direction.

45. The apparatus as claimed in claim 44, wherein said at least one displacement body has a cross sectional dimension, and wherein said at least one displacement body projects out of said nozzle in the drawing direction by at least half said cross sectional dimension.

46. The apparatus as claimed in claim 44, wherein said at least one displacement body comprises a body boundary in contact with the at least one settable liquid, said body boundary ending in a point or sharp edge and said body boundary being arranged outside said nozzle.

47. The apparatus as claimed in claim 44, wherein said outer shell comprises a shell boundary that is in contact with the hollow strand, said shell boundary comprising break-off edge in the drawing direction, wherein detaching of the hollow strand from said nozzle takes place substantially at said break-off edge.

48. The apparatus as claimed in claim 47, wherein said shell boundary comprises a material that is poorly wetted by the at least one settable liquid.

49. The apparatus as claimed in claim 44, further comprising connecting elements for connecting said at least one displacement body to said nozzle.

50. The apparatus as claimed in claim 44, wherein said at least one displacement body is held by a holder such that it can slide in a horizontal and/or a vertical direction with respect to said nozzle.

51. The apparatus as claimed in claim 44, wherein said outer shell is cylindrical.

52. The apparatus as claimed in claim 44, wherein said at least one displacement body is cylindrical.

53. The apparatus as claimed in claim 44, wherein said at least one displacement body is arranged coaxially with respect to said nozzle.

54. The apparatus as claimed in claim 44, wherein said at least one displacement body and said nozzle define a gap therebetween, said gap being sufficient to permit a predeterminable throughput at a given viscosity of the at least one settable liquid.

55. The apparatus as claimed in claim 44, wherein said at least one displacement body comprises dimensions that are not constant in a plane that is perpendicular to a longitudinal axes of said at least one displacement body.

56. The apparatus as claimed in claim 44, further comprising a temperature-control device for controlling a temperature of said outer shell and/or of said at least one displacement body.

57. The apparatus as claimed in claim 56, wherein said temperature-control device comprises a muffle arranged beneath said nozzle.

58. The apparatus as claimed claim 56, wherein said temperature-control device comprises an inductive heating device.

59. The apparatus as claimed in claim 56, wherein said temperature-control device comprises at least one temperature-control element having a variably adjustable position.

60. The apparatus as claimed in claim 56, wherein said temperature-control device comprises at least two temperature-control elements that are independent of one another.

61. The apparatus as claimed in claim 44, further comprising a device for applying a liquid to the hollow strand.

62. The apparatus as claimed in claim 44, wherein said at least one displacement body comprises a material selected from the group consisting of a high-melting metal, a precious metal, a refractory metal, a ceramic material, an alloy of one or more of the foregoing, and any combinations thereof.

63. The apparatus as claimed in claim 44, further comprising a device for generating a pressure difference between an interior and an exterior of the hollow strand.

64. A process for producing a hollow strand, comprising:
providing a settable liquid;
producing a hollow strand by drawing said settable liquid out of a nozzle in a drawing direction, said nozzle having an outer shell and a needle; and
arranging a hollow displacement body that is open with respect to said settable liquid in said nozzle between said outer shell and said needle so that a portion of said hollow displacement body projects out of said nozzle in said drawing direction.

65. The process as claimed in claim 64, wherein displacement body and said nozzle define a gap therebetween, said gap being sufficient to permit a predeterminable throughput at a given viscosity of the settable liquid.

66. The process as claimed in claim 65, further comprising adjusting a position of said displacement body horizontally and/or vertically adjustable.

67. The process as claimed in claim 66, further comprising adjusting a length of said portion as a result of adjusting said position so that said settable liquid has a viscosity that is sufficiently high for the hollow strand to be under tensile stress during drawing.

68. The process as claimed in claim 64, further comprising controlling a temperature of said outer shell and/or of said displacement body.

69. The process as claimed in claim 64, further comprising setting a temperature surrounding the hollow strand so that said settable liquid, at a lower end of said displacement body, has a viscosity that is sufficiently high for the hollow strand to be under tensile stress during drawing.

70. The process as claimed in claim 65, further comprising adjusting a position of at least one temperature-control element.

71. The process as claimed in claim 64, further comprising applying a liquid to the hollow strand in draw bulb region.

72. The process as claimed in claim 64, further comprising setting said settable liquid to form a tube.

73. The process as claimed in claim 64, further comprising generating a pressure difference between an interior and an exterior of the hollow strand.

74. The process as claimed in claim 64, wherein said settable liquid comprises a glass melt.

75. The process as claimed in claim 64, wherein the hollow strand has a substantially amorphous solid.

76. The process as claimed in claim 75, wherein the hollow strand comprises glass.

77. The process as claimed in claim 64, wherein the hollow strand has a surface on the inner side and or an outer side of the tube is substantially smooth.

78. The process as claimed in claim 76, further comprising converting the hollow strand into a glass-ceramic by targeted bulk crystallization, and wherein the hollow strand comprises a glass-ceramic tube having Zerodur.

79. A fiber produced that has been manufactured using the process as in claim 64, wherein the fiber is substantially free of crystallization at the surface and has substantially no unevenness at free surfaces.
